(19) United States
(12) Patent Application Publication
(10) Pub. No.: US 2017/0323404 A1
(43) Pub. Date: Nov. 9, 2017

(54) METHODS AND SYSTEMS FOR MANAGING TRAVEL EXPENDITURE

(71) Applicant: Mastercard International Incorporated, Purchase, NY (US)

(72) Inventors: Rakesh TIWARI, Delhi (IN); Abhishek GAUTAM, Delhi (IN); Shashank Kumar TRIVEDI, New Delhi (IN)

(73) Assignee: Mastercard International Incorporated, Purchase, NY (US)

(21) Appl. No.: 15/449,194

(22) Filed: Mar. 3, 2017

(30) Foreign Application Priority Data
May 3, 2016 (SG) 10201603501X

(51) Int. Cl. G06Q 50/14; G06Q 40/00; G06Q 30/02

(52) U.S. Cl. CPC G06Q 50/14; G06Q 30/0282; G06Q 40/12; G06Q 30/0255

(57) ABSTRACT

A computerised method for managing travel expenditure is disclosed. The method comprises: receiving travel data for a traveller's proposed trip, the travel data comprising at least a travel budget and travel destination; receiving a user profile comprising at least an indication of spend level preference for the traveller; obtaining historic travel expenditure data for a plurality of customers; analysing the historic travel expenditure data in light of the travel data and user profile to determine an optimal proposed spend allocation for the traveller across different travel spend streams; and communicating the proposed spend allocation to the traveller along with a listing of potential merchants for each spend stream, the potential merchants being extracted from the historic travel expenditure data.

### FIELD OF THE INVENTION

The present invention relates to methods and systems for managing travel expenditure.

### BACKGROUND OF THE INVENTION

Whether travelling for business, leisure or visiting friends or relatives, most travellers would like to experience a quality service at a fair price.

Although travellers may set a budget for a proposed trip, they must currently undertake their own research to determine how best to allocate portions of their budget for different trip expenditure (e.g. flights, hotels, eating, shopping, entertainment and attractions). If they are unfamiliar with the travel destination they may not know what costs to expect for such travel expenses and they may find it difficult to establish whether, say, a particular restaurant is relatively typical, cheap, or expensive for that destination and/or type of restaurant.

There is therefore a need for improved methods and systems to help travellers to manage their travel expenditure.

### SUMMARY OF THE INVENTION

In accordance with a first aspect of the present invention there is provided a computerised method for managing travel expenditure comprising:

a) receiving, by a management component, travel data for a traveller's proposed trip, said travel data comprising at least a travel budget and travel destination;

b) receiving, by a management component, a user profile comprising at least an indication of spend level preference for the traveller;

c) obtaining, from a database, historic travel expenditure data for a plurality of customers;

d) analysing, by the management component, the historic travel expenditure data in light of the travel data and user profile to determine an optimal proposed spend allocation for the traveller across different travel spend streams; and

e) communicating the proposed spend allocation to the traveller along with a listing of potential merchants for each spend stream, the potential merchants being extracted from the historic travel expenditure data.

Embodiments of the present invention therefore provide a computerised method for generating a detailed budget for a planned trip, including a proposed spend allocation across different travel spend streams, which is based on actual historic spend data by customers which may have similar characteristics (e.g. spending preferences) to the traveller. The method also provides information on potential merchants extracted from such historic data so that the traveller can easily select a suitable merchant within their proposed budget. Thus, travellers can manage and optimise their budget by drawing on a large database of experience from previous similar travellers using preferred merchants.

The different travel spend streams may comprise flights and other transportation, hotels or other lodgings, eating, shopping, entertainment and attractions.

Advantageously, embodiments of the invention can be utilised for trip planning (e.g. to identify flights, hotels and related travel services such as airport transfers). In addition, embodiments of the invention may be utilised during the trip (e.g. to identify restaurants, shops and attractions) at the destination. In some embodiments, the method may comprise utilising a positioning system (e.g. GPS) of a portable electronic device carried by the traveller to determine the traveller's location and identify and present nearby potential merchant options (e.g. restaurants or shops) to the traveller within their specified budget. Thus, the traveller may be provided with real-time data taking into account their location and budget. The potential merchants in the locality of the traveller may be identified on a map.

Step d) may comprise segmenting the historic travel expenditure data by customer demographic data, identifying a customer segment with characteristics similar to the user profile and using the identified customer segment to calculate the spend allocation.

In step e) the potential merchants may be ranked according to a frequency of transactions with the merchants by the identified customer segment. The listing of potential merchants may also include ratings and other descriptions to help a traveller make an informed decision about which merchants to use.

In step d) and/or e) the historic travel expenditure data may be filtered to identify transactions with merchants located at the travel destination.

The spend level preference may, for example, be budget, average or luxury. The spend level preference may be expressly indicated in the user profile or may be implied from other user characteristics (e.g. demographics such as age, occupation, monthly income, homeowner status, marital status and number of dependants; or behavioural data such as from past transaction data).

The method may further comprise tracking the traveller's spend in relation to the trip, calculating a remaining budget for the trip and dynamically optimising the proposed spend allocation (e.g. between eating places, shopping and hotel expenses etc.) based on the remaining budget. In order to track the traveller's spend the method may comprise linking at least one payment vehicle to the user profile such that travel expenditure made through the payment vehicle can be logged in order to track the amount spent and budget remaining in relation to each travel spend stream. The method may further comprise generating and communicating updates to the traveller regarding the amount spent and/or budget remaining in relation to each travel spend stream. The updates may be communicated by SMS, email, HTML or push notifications through a mobile application.

As used in this document, the term “payment vehicle” refers to any suitable payment mechanism, such as by cash, a credit card, a debit card, a prepaid card, a charge card, a membership card, a promotional card, a frequent flyer card, a gift card, and/or any other physical or electronic device that may hold payment account information, such as digital wallets, mobile phones, Smartphones, personal digital assistants (PDAs), key fobs, transponder devices, NFC-enabled devices, tablets and/or computers. Thus, in certain embodiments the payment vehicle may take the form of a payment card or a digital wallet.

The digital wallet may be configured to receive pre-paid funds (e.g. from an owner's bank account). In this way, the owner may select an amount to pay into the digital wallet (e.g. on an ad hoc, daily, weekly, monthly, quarterly or annual basis). It is believed that such a system carries less risk of unauthorised transactions than if the wallet was linked directly to the owner's bank account or credit card, for example, if the customer's mobile device and/or digital wallet were stolen. However, in some embodiments, the digital wallet may be linked to another type of payment vehicle such as a credit card or debit card.

Known “Payment Tokenization” methodology may be employed to reduce security risks inherent in the collection and transfer of highly sensitive data such as credit card Personal Account Numbers (PAN). With this methodology, it is the tokenized pseudo-PAN that is sent from a point of sale (POS) terminal to the issuer for transaction authorization. The issuer uses the tokenization system to de-tokenize the pseudo-PAN and match it to the real account data. The pseudo-PAN cannot be reversed or de-tokenized by any other entity other than the trusted tokenization system.

In some embodiments, more than one payment vehicle may be linked to the user profile. For example, a pre-paid card, a credit card and a digital wallet. Furthermore, the payment vehicles may be associated with one or more persons. For example, payment cards in the names of a husband and wife may both be linked to a single (primary) user profile to track overall family spending.

In relation to cash spending, the method may comprise an option for the traveller to input spend details (e.g. including spend amount, merchant name, location and spend type such as restaurant) to the management component.

The method may further comprise post-trip spend analysis comprising comparing actual spend against the proposed spend allocation and/or budget. This analysis may further comprise generating recommendations for the traveller to optimise expenditure for future trips.

The method may further comprise the traveller installing a management component application in a portable electronic device, the management component application being configured to carry out method steps a) to e). The management component application may further obtain data from a payment vehicle in order to track the traveller's spend.

The travel data may comprise the duration of the trip, the timing of the trip (e.g. whether travelling at a peak time or otherwise) and the number and ages of all travellers on the trip.

In accordance with a second aspect of the present invention there is provided a computer system for managing travel expenditure comprising:

a) a database of historic travel expenditure data for a plurality of customers; and

b) a management component comprising a processor configured to:

i. receive travel data for a traveller's proposed trip, said travel data comprising at least a travel budget and location of travel;

ii. receive a user profile comprising at least an indication of spend level preference for the traveller;

iii. analyse the historic travel expenditure data in light of the travel data and user profile to determine an optimal proposed spend allocation for the traveller across different travel spend streams; and

iv. communicate the proposed spend allocation to the traveller along with a listing of potential merchants for each spend stream, the potential merchants being extracted from the historic travel expenditure data.

The management component may comprise a digital wallet associated with the user profile.

A dynamic spend optimiser may be provided to optimise the spend allocation across the different travel spend streams when payments are recorded. The dynamic spend optimiser may utilise linear or non-linear programming.

The management component may be provided in the form of an application running on a traveller's portable electronic device (e.g., mobile phone, tablet or laptop).

Alternatively, the management component may be located on a server and accessible (e.g. by wired or wireless technology) by an application running on a traveller's portable electronic device.

In some embodiments, the application may comprise a contactless payment vehicle which is also configured as a budget controlling tool.

Embodiments of the invention may be expressed as a network of communicating devices (a “computerized network”) or in terms of a software application downloadable into a computer device to facilitate the method. The software application is a computer program product, which may be stored in non-transitory form on a tangible data-storage device (such as a storage device of a server, or one within a communication device).

### BRIEF DESCRIPTION OF THE DRAWINGS

Embodiments of the invention will now be described for the sake of example only with reference to the following drawings, in which:

FIG. 1 illustrates a computerised method for performing a method in accordance with a first embodiment of the invention;

FIG. 2 illustrates a computerised network of electronic devices for performing the method of FIG. 1;

FIG. 3 shows a block diagram of the technical architecture of the server of FIG. 2; and

FIG. 4 shows a block diagram of the communication device of FIG. 2.

### DETAILED DESCRIPTION OF CERTAIN EMBODIMENTS

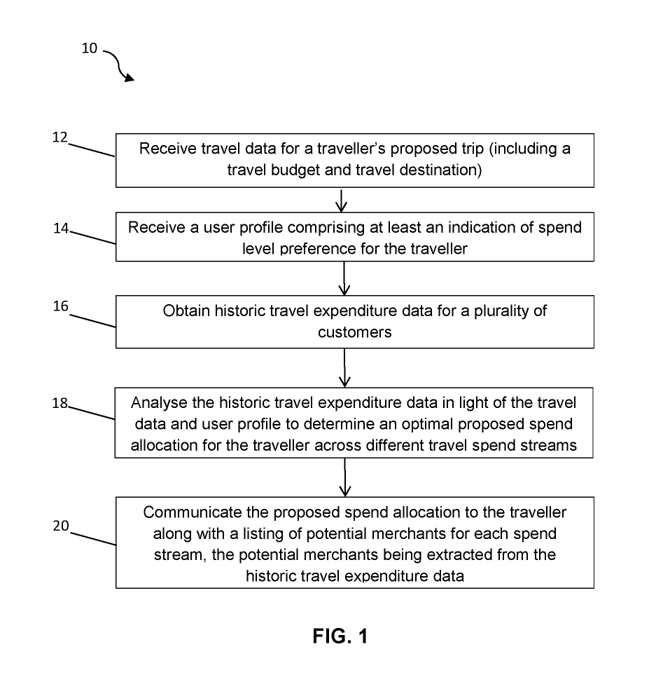

FIG. 1 shows a computerised method 10 for managing travel expenditure in accordance with a first embodiment of the invention. The method 10 comprises the following steps:

Step 12: receiving, by a management component, travel data for a traveller's proposed trip, said travel data comprising at least a travel budget and travel destination;

Step 14: receiving, by a management component, a user profile comprising at least an indication of spend level preference for the traveller;

Step 16: obtaining, from a database, historic travel expenditure data for a plurality of customers;

Step 18: analysing, by the management component, the historic travel expenditure data in light of the travel data and user profile to determine an optimal proposed spend allocation for the traveller across different travel spend streams; and

Step 20: communicating the proposed spend allocation to the traveller along with a listing of potential merchants for each spend stream, the potential merchants being extracted from the historic travel expenditure data.

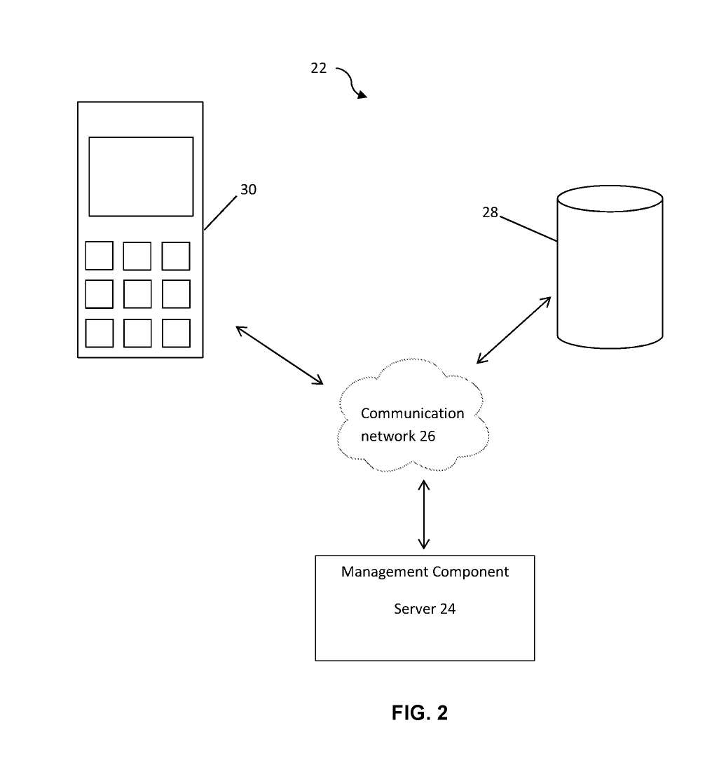

FIG. 2 illustrates a computer system 22 of electronic devices for performing the method of FIG. 1. Thus, the system 22 comprises a management component in the form of a server 24, connected via a communication network 26 to a database 28 of historic travel expenditure data. The management component server 24 comprises a processor configured to carry out the method of FIG. 1. A customer mobile device 30 is also shown in communication with the network 26. The customer mobile device 30 is associated with the traveller.

In FIG. 2, the customer mobile device 30 is depicted as a smartphone, however it may be any mobile electronic communication device, such as a tablet computer or laptop.

The database 28 of historic travel expenditure data may comprise profile and transaction data for a plurality of customers. The data may comprise transaction amount, transaction count, card product, merchant location, merchant industry (e.g. airline), merchant category (e.g. budget), merchant name, marital status, monthly income, number of dependents and home-owner status etc.

The operation of the components of the system 22 will now be described with reference to the computerised method 10 for managing travel expenditure in accordance with an embodiment of the invention. In this embodiment, we will consider an example where Mr X plans to travel from India to London with his wife and one child for one week. Mr X has a travel budget of GBP 5k. Mr X has a user profile that states that he is recently married, has a monthly income in a range A-B and has his own home. This information is entered into Mr X's mobile device 30 through an application configured to communicate over the network 26 with the management component server 24. In alternative embodiments, this information (or parts thereof) may be derived from analysis of past transactions or other data sources available to the management component server 24.

The management component server 24 analyses the information provided and determines that Mr X belongs to an upper middle class Segment A. In some embodiments, the segmentation may be related to the home country of the traveller as the spending habits and consumption preferences may be highly dependent on the home country. This analysis comprises retrieving data from database 28 and filtering the data to group customers with similar characteristics to Mr X (e.g. with a similar income, travel budget, transaction profile etc.). The analysis will further comprise filtering the data of the customers in Segment A to identify the merchants with whom the customers had transactions in the travel destination (in this case, London). The merchants may further be ranked based on how frequently customers in Segment A transacted with them (i.e. how popular the merchants are with such customers). The merchants may also be ranked on the basis of other criteria such as budget. This analysis therefore allows the management component to suggest potential merchants for the traveller to use in their travel destination based on past travel expenditure data from travellers with similar characteristics to Mr X. Thus, lists of potential airlines, hotels, restaurants, shops (e.g. for luxury clothing brands) or attractions can be provide to Mr X through his mobile device 30.

Furthermore, the management component server 24 will analyse past transaction data from the customers in Segment A to determine an optimum spend allocation for Mr X across different travel spend streams. For example, it may be determined that the travel budget should be split in line with the following: airline expenditure 25%-30%; hotel expenditure 20%-25%; eating expenditure 20%-35%; shopping expenditure 10%-20%; and other expenditure 5%-15%. This split will be communicated to Mr X through the application on his mobile device 30.

During the trip, or when travel expenditure arises (e.g. booking flights, hotels etc.), the details of such expenditure may be communicated to the management component server 24 so the allocation of the remaining budget can be updated, if necessary. The communication may comprise Mr X entering the expenditure details into his mobile device 30. However, it is advantageous for the payment vehicle to be identified in the mobile application such that transactions made through a registered payment vehicle are automatically identified and communicated to the management component server 24. Thus, a payment card or digital wallet may be identified and linked to the user profile such that use of the payment card or digital wallet is monitored and any travel-related expenditure is identified. For example, a payment card transaction database operated by the card issuer may communicate transaction data comprising travel expenditure to the management component server 24. In the case that the management component server 24 is unsure whether a transaction is actually associated with travel expenditure and should be included in the travel budget (e.g. for buying swim wear prior to departure for a beach vacation) the management component server 24 may notify Mr X of the transaction and seek confirmation as to whether or not the transaction should be included in the travel budget. This notification may be via an application operating on Mr X's mobile device 30.

Mr X's mobile device 30 could include a dashboard (running on an application) which would get updated every day and change the spend allocation dynamically based on the total spent amount and remaining amount left as per Mr X's budget. In case the traveller is using a payment card or any other payment vehicle that is not registered with the application then Mr X could notify the management component server 24 of spend data via SMS or E-mail. A recommendation database could be connected to a payment card transaction database to use near real-time transaction data to analyse traveller spend and provide recommendations for amending the budget allocation.

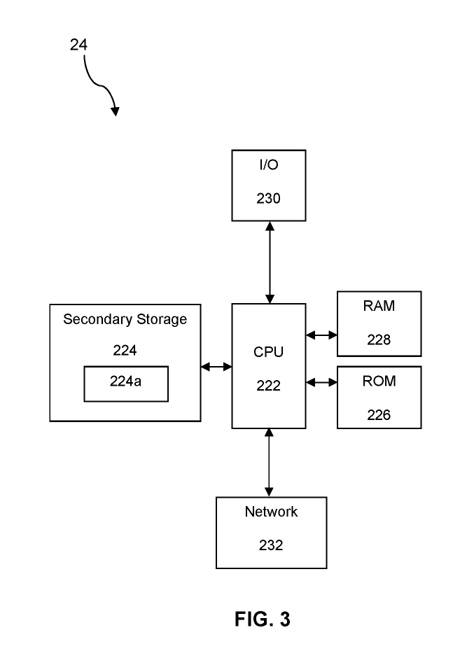

FIG. 3 is a block diagram showing a technical architecture of the management component server 24.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

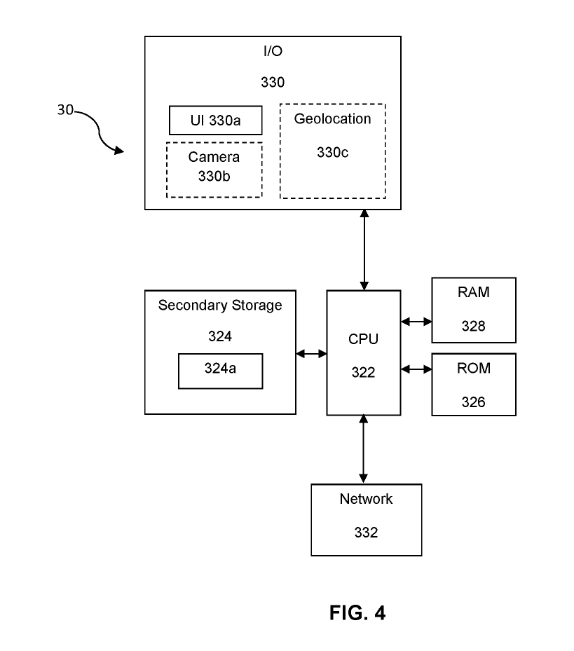

FIG. 4 is a block diagram showing a technical architecture of the customer mobile device 30.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a. In the case of the customer mobile device 30, a camera 330b and a geolocation module 330c may also be provided. The UI 330a may comprise a touch screen, keyboard, keypad or other known input device. The camera 330b allows a user to capture images and save the captured images in electronic form. The geolocation module 330c is operable to determine the geolocation of the communication device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a processing component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiments can be made in accordance with the appended claims.

1. A computerised method for managing travel expenditure comprising:
a) receiving, by a management component, travel data for a traveller's proposed trip, said travel data comprising at least a travel budget and travel destination;
b) receiving, by a management component, a user profile comprising at least an indication of spend level preference for the traveller;
c) obtaining, from a database, historic travel expenditure data for a plurality of customers;
d) analysing, by the management component, the historic travel expenditure data in light of the travel data and user profile to determine an optimal proposed spend allocation for the traveller across different travel spend streams; and
e) communicating the proposed spend allocation to the traveller along with a listing of potential merchants for each spend stream, the potential merchants being extracted from the historic travel expenditure data.

2. The method according to claim 1 wherein the different travel spend streams comprise one or more of transportation, lodging, eating, shopping, entertainment and attractions.

3. The method according to claim 1 further comprising utilising a positioning system of a portable electronic device carried by the traveller to determine the traveller's location and present nearby potential merchants identified in step e).

4. The method according to claim 1 comprising indicating a location of a potential merchant on a map.

5. The method according to claim 1 wherein step d) comprises segmenting the historic travel expenditure data by customer demographic data, identifying a customer segment with characteristics similar to the user profile and using the identified customer segment to calculate the spend allocation.

6. The method according to claim 5 wherein in step e) the potential merchants are ranked according to a frequency of transactions with the merchants by the identified customer segment.

7. The method according to claim 1 wherein the listing of potential merchants also includes ratings and other descriptions to help a traveller make an informed decision about which merchants to use.

8. The method according to claim 1 wherein in step d) and/or step e) the historic travel expenditure data is filtered to identify transactions with merchants located at the travel destination.

9. The method according to claim 1 wherein the spend level preference is budget, average or luxury.

10. The method according to claim 1 wherein the spend level preference is expressly indicated in the user profile.

11. The method according to claim 1 wherein the spend level preference is implied from user characteristics.

12. The method according to claim 1 further comprising tracking the traveller's spend in relation to the trip, calculating a remaining budget for the trip and dynamically optimising the proposed spend allocation based on the remaining budget.

13. The method according to claim 1 further comprising linking at least one payment vehicle to the user profile such that travel expenditure made through the payment vehicle can be logged in order to track the amount spent and budget remaining in relation to each travel spend stream.

14. The method according to claim 1 further comprising generating and communicating updates to the traveller regarding the amount spent and/or budget remaining in relation to each travel spend stream.

15. The method according to claim 14 wherein the updates are communicated by SMS, email, HTML or push notifications through a mobile application.

16. The method according to claim 13 wherein the payment vehicle comprises a payment card or digital wallet.

17. The method according to claim 13 wherein payment tokenisation methodology is employed.

18. The method according to claim 13 wherein more than one payment vehicle is linked to the user profile.

19. The method according to claim 14 wherein the payment vehicles are associated with more than one person.

20. The method according to claim 1 comprising an option for the traveller to input spend details to the management component.

21. The method according to claim 1 further comprising post-trip spend analysis comprising comparing actual spend against the proposed spend allocation and/or budget.

22. The method according to claim 21 further comprising generating recommendations for the traveller to optimise expenditure for future trips.

23. The method according to claim 1 further comprising the traveller installing a management component application in a portable electronic device, the management component application being configured to carry out method steps a) to e).

24. The method according to claim 23 wherein the management component application is configured to obtain data from a payment vehicle in order to track the traveller's spend.

25. The method according to claim 1 wherein the travel data comprises one or more of: the duration of the trip, the timing of the trip and the number and ages of all travellers going on the trip.

26. A computer system for managing travel expenditure comprising:
a) a database of historic travel expenditure data for a plurality of customers; and
b) a management component comprising a processor configured to:
i. receive travel data for a traveller's proposed trip, said travel data comprising at least a travel budget and location of travel;
ii. receive a user profile comprising at least an indication of spend level preference for the traveller;
iii. analyse the historic travel expenditure data in light of the travel data and user profile to determine an optimal proposed spend allocation for the traveller across different travel spend streams; and
iv. communicate the proposed spend allocation to the traveller along with a listing of potential merchants for each spend stream, the potential merchants being extracted from the historic travel expenditure data.

27. The system according to claim 26 wherein the management component comprises a digital wallet associated with the user profile.

28. The system according to claim 26 wherein a dynamic spend optimiser is provided to optimise the spend allocation across the different travel spend streams when payments are recorded.

29. The system according to claim 26 wherein the management component is provided in the form of an application running on a traveller's portable electronic device.

30. The system according to claim 26 wherein the management component is located on a server and accessible by an application running on a traveller's portable electronic device.

31. The system according to any one of claims 29 wherein the application comprises a contactless payment vehicle which is also configured as a budget controlling tool.

32. A computer program product configured to carry out the method of claim 1, stored in non-transitory form on a tangible data-storage device.
